(19) United States
(12) Patent Application Publication
(10) Pub. No.: US 2007/0217960 A1
(43) Pub. Date: Sep. 20, 2007

(54) Device for collection of liquid samples

(76) Inventor: Mark Sekela, Coquitlam (CA)

Correspondence Address: WINSTON & STRAWN LLP;PATENT DEPARTMENT, 1700 K STREET, N.W., WASHINGTON, DC, 20006, US

(21) Appl. No.: 11/378,693

(22) Filed: Mar. 17, 2006

(51) Int. Cl. B01L 3/00

(52) U.S. Cl. 422/102

(57) ABSTRACT

The present invention provides a device for collection of liquid samples under atmospherically-isolated conditions, the device including a hermetically-sealable chamber having one or more sample manipulating members or similar equipment within the chamber, and a pump system for drawing liquid through a sampling tube into the chamber directly or into a container. The container includes an outlet within the chamber for dispensing the collected sample under atmospherically-isolated conditions. Also provided is a device wherein the pump system that includes an outlet within the chamber for dispensing collected liquid sample.

### FIELD OF INVENTION

The present invention relates to devices for collection of liquid samples.

### BACKGROUND OF THE INVENTION

A variety of devices for the collection of liquid samples are known in the art. However, the inventors are unaware of any devices that permit the collection of liquid samples under atmospherically-isolated or atmospherically-controlled conditions. Thus, there is a need in the art for devices that permit collection of liquid samples under atmospherically-isolated and/or atmospherically-controlled conditions. Further, there is a need in the art for a portable device that may be transported and used in a remote location for collection of liquid samples under atmospherically-isolated and/or atmospherically-controlled conditions.

### SUMMARY OF THE INVENTION

The present invention relates to devices for collection of liquid samples.

According to the present invention, there is provided a device for collection of liquid samples under atmospherically-isolated conditions comprising,

a hermetically sealable chamber comprising one or more means for manipulating samples or equipment within the chamber, and;

a pump system for drawing liquid through a sampling tube into a container wherein the container comprises an outlet within the chamber for dispensing the collected sample.

Also contemplated by the present invention is a device as defined above wherein the atmospherically-isolated conditions further comprise atmospherically-controlled conditions. The atmospherically-controlled conditions may comprise, but are not limited to, temperature, gas composition, humidity, pressure, lighting or any combination thereof.

The present invention also provides a device as defined above wherein the hermetically-sealable chamber comprises a closable door forming an air-tight seal separating the atmosphere in the container from that outside the container.

The present invention also contemplates a device as defined above, further comprising a docking port for transfer of sample or equipment to or from the container under controlled conditions.

The present invention also contemplates a device as defined above wherein the one or more means for manipulating samples or equipment comprises at least two gloves extending into the chamber.

The present invention also contemplates a device as defined above wherein the pump system comprises a pump having a suction tube connected directly or indirectly to the container at a first attachment point for reducing pressure therein, and a sampling tube connected to the container at a second attachment point, wherein liquid sample is drawn into the container via the sampling tube under reduced pressure in the container.

The present invention also provides a device as defined above, further comprising an overflow container or vessel attached in series between the pump and the container.

The present invention also contemplates a device as defined above wherein the pump comprises a first suction hose connected to the overflow vessel at a first attachment point, and a second suction hose connecting the overflow vessel at a second attachment point to the container.

The present invention also provides a device as defined above wherein the container comprises a plug having a first fitting attached to a suction hose, and a second fitting attached to a sample collection tube. In a further embodiment, the plug may comprise a third fitting having a valve for equalizing pressure within the container. In still a further embodiment, the third fitting may be connected to a source of compressed gas.

The present invention also contemplates a device as defined above wherein the chamber comprises one or more connection members in the wall thereof for continuous transmission of

a) a suction or other force between a hose or tube outside the chamber and a second hose or tube inside the chamber, or

b) an electrical current between a power cord or electrical wire inside the chamber and a power cord or electrical wire outside the chamber.

The present invention also provides a device as defined above wherein the sampling tube comprises a valve or stop-cock to control the flow of liquid therethrough.

The present invention also provides a device for collection of liquid samples under atmospherically-isolated conditions comprising,

a hermetically sealable chamber comprising one or more means for manipulating samples or equipment within the chamber, and;

a pump system for moving liquid through a sampling tube, the pump system comprising an outlet within said chamber for dispensing collected liquid sample. The present invention also contemplates a device comprising any additional feature or combination of additional features as described herein.

This summary of the invention does not necessarily describe all features of the invention.

### BRIEF DESCRIPTION OF THE DRAWINGS

These and other features of the invention will become more apparent from the following description in which reference is made to the appended drawings wherein:

FIG. 1 shows a perspective view of a representative embodiment of the present invention.

FIG. 2 shows a perspective view of a representative embodiment of the present invention.

FIG. 3 shows a perspective view of a representative embodiment of the present invention.

### DETAILED DESCRIPTION

The present invention relates to devices for collection of liquid samples.

The following description is of a preferred embodiment.

According to the present invention, there is provided a device for collection of liquid samples under atmospherically-isolated conditions comprising,

a hermetically-sealable chamber comprising one or more means for manipulating samples or equipment within the chamber, and;

a pump system for drawing liquid through a sampling tube into a container wherein the container comprises an outlet within the chamber for dispensing collected sample.

In an alternate embodiment, there is provided a device for collection of liquid samples under atmopherically-isolated conditions comprising,

a hermetically sealable chamber comprising one or more means for manipulating samples or equipment with the chamber, and;

a pump system for moving liquid through a sampling tube, the pump system comprising an outlet within said chamber for dispensing collected liquid sample.

By the term “atmospherically-isolated” it is meant that the environment outside the container is separated from the environment within the container when the chamber is hermetically sealed. In this manner, the collection of liquid samples may be performed under controlled conditions, such that the samples do not come in contact with the ambient atmosphere. For example, but not to be considered limiting in any manner, the device of the present invention may be employed to obtain water samples at specific depths from a body of water such as, but not limited to a lake. It is to be understood that the surface of the lake may be in contact with the ambient atmosphere. However, in the context of the present invention, the water collected below the surface is considered “atmospherically-isolated” as there is no direct contact of the water with the ambient atmosphere. Because the ambient atmosphere may comprise a variety of chemicals, pollutants, atmospheric gases and other components that could contaminate samples obtained below the surface of the lake if such samples were exposed to the ambient atmosphere during or after collection, there is a need to be able to obtain liquid samples under atmospherically-isolated conditions. It is also contemplated that the device of the present invention may be employed in other situations to collect liquid samples.

The device of the present invention comprises a hermetically-sealable chamber that provides atmospherically-isolated conditions. Preferably the chamber comprises a sealable door or the like that provides access to the interior of the chamber when open, but provides an air-tight seal when closed. Alternatively, the chamber may comprise one or more apertures providing access to the interior of the chamber, the apertures capable of being sealed, for example, but not limited to, by attaching one or more sample manipulation means as described herein.

The chamber may comprise a single section or the chamber may be divided into two or more sections. For example, the chamber may be partitioned into two sections by a shelf, platform, partition, compartment or the like. In an embodiment of the present invention, which is not meant to be limiting in any manner, the chamber comprises an upper portion housing a pump and a lower portion comprising a pump control panel and one or more means for manipulating samples or equipment within the chamber.

Preferably the device comprises a sealable door or the like that provides access to the interior of the chamber when open, but provides an air-tight seal when closed. The chamber of the present invention may further comprise one or more docking ports permitting transfer of sample or equipment in or out of the chamber under controlled conditions.

It is further contemplated that the environment within the chamber may be controlled, for example in temperature, humidity, gas composition, pressure, lighting of all types including, but not limited to visable, ultraviolet, infrared, etc or any combination thereof. In an embodiment of the present invention, which is not meant to be limiting, the environment within the chamber comprises a gas, or a mixture of gases including, inert and/or other gases such as, but not limited to argon, helium, neon, nitrogen, oxygen, carbon dioxide, air, or any combination thereof. In a preferred embodiment, the gas is an inert gas.

Accordingly, the present invention contemplates a device for collection of liquid samples under atmospherically-isolated conditions, the device optionally comprising one or more compressed gas sources, a humidity control device, a pressure modulation means, a heater, a light or panel of lights, or any combination thereof.

By the term “means for manipulating”, it is meant one or more electronic or manual devices, for example, but not limited to, one or more gloves integral with the chamber and extending therein to permit dispensing and/or manipulation of the collected liquid samples, and optionally manipulation of any equipment within the chamber, for example, but not limited to one or more pumps, compressed gas sources, hoses, tubes, fittings, power cords, plugs, heaters, pH meters, conductivity meters, thermometers, lights, humidity control devices, pressure modulation means, control panels including, without limitation, pump controls, temperature controls, humidity controls, power switches, valves including but not limited to one or more gas control valves, sample outlet flow valve, fixture valves or stop-cocks, clamps, sample bottles, test tubes or the like, fraction collectors, or any other equipment or combination of equipment that may be used in the container. In a preferred embodiment, the means for manipulating comprises one or more gloves, preferably a pair of gloves integral with and extending into the chamber. The gloves may be made of any suitable material known in the art that permits the collected liquid sample and/or equipment in the chamber to be manipulated. In a preferred embodiment, the gloves are made of rubber including, but not limited to synthetic or natural rubber, polypropylene, Teflon® or any other non-contaminating, substantially-inert substance.

The opening of each glove may be reversibly sealed to the chamber around an aperture such that a person may pass their hands through the aperture into a glove and manipulate samples and other components within the chamber without contaminating the interior of the chamber with the outside environment. Without wishing to be limiting, each glove may be sealed to the chamber or a member forming a channel in the chamber by a clamp, for example, but not limited to a circular compression clamp or the like. Other ways of sealing a glove to the container as known in the art may also be employed.

In an alternate embodiment, it is contemplated that an electronic system, robotic system or the like may be employed to dispense, handle and/or manipulate samples and/or equipment within the chamber. Such a system may be programmed to work automatically or it may be controlled inside or outside of the chamber. For example, but not wishing to be limiting, a valve on the outlet of the container may be controlled electronically to dispense an aliquot of the collected sample into a sample bottle, test tube or the like. Other means of manipulating samples that are known in the art are also included.

By the term “pump system” it is meant one or more pumps, tubes, hoses, clamps, fittings, valves, power cords and the like that may be employed to draw or push liquid through a sampling tube into an appropriate container. The one or more pumps may comprise any pump known in the art, for example, but not limited to a bladder pump system, a positive displacement pump system, or a vacuum displacement pump system as known in the art. In a preferred embodiment, which is not meant to be limiting, the pump is a vacuum displacement pump. In an alternate embodiment, which is not meant to be limiting in any manner, the device comprises positive displacement pump, for example, but not limited to a stainless steel Grundfos positive displacement pump connected to a valve controlled “T” split. From the “T” split, there may be connected a magnetic meter, for example, but not limited to a Burkert Insertion Mag Meter with an air driven diaphram valve all controlled electronically inside the sample chamber by a Burkert Controller. This embodiment allows a precise portioning of liquid sample into an appropriate container under environmentally-isolated and optionally environmentally-controlled conditions. Also, as will be appreciated by a person of skill in the art, such an embodiment may obviate the need for a container comprising an outlet within the chamber as the collected liquid sample can be portioned directly into test tubes, sample containers or the like within the chamber.

It is also contemplated that the device of the present invention may comprise a filter, screen, sieve or the like for removing particulate matter from the liquid sample. The filter or the like may be integral with, or attached to the sample collection tube, the container or outlet in order to remove particulate matter.

As will be evident to someone of skill the art, the container, hoses and tubes employed in the device of the present invention are substantially non-collapsible under reduced pressure. For example, but not wishing to be limiting, the hoses and tubes may be Teflon®, silicone, polypropylene or Tygon® tubing, or the like.

Any hose or tube employed in the present invention may further comprise a valve, stop-cock or the like for reversible blockage of the channel contained therein. In this way suction and other forces causing flow of liquid may be modulated in the hose or tube. In particular, uptake of sample by the sample collection tube may be stopped by closing a valve in the tube, thereby preventing further uptake of the sample and contamination of the sample by the ambient atmosphere when the sample collection tube is removed from the liquid.

The container, if employed in the device of the present invention for collection of liquid samples may comprise any suitable container, vessel, flask or the like known in the art. It is to be understood that the container is also substantially non-collapsible under reduced pressure. In general, but without wishing to be limiting in any manner, the container is attached at separate positions to a sample collection tube and a suction hose, respectively. The pump provides a suction force via the suction hose to draw liquid through the sample collection tube into the container.

As described previously, the container comprises an outlet within the chamber for dispensing the collected sample under atmospherically-isolated and optionally atmospherically-controlled conditions. A majority of the container may be attached on the outside of the chamber, with only the outlet, or a portion of the outlet within the chamber. Alternatively, the entire container may be attached inside the chamber. In still a further embodiment, the outlet may comprise a tube or hose attached to it, the tube or hose in the chamber of the device.

It is also contemplated that the chamber may comprise a separate compartment or extension projecting therefrom which houses the container. Preferably the compartment or extension projects upwardly from the top portion of the chamber. By having the container housed in such a compartment, the collection of liquid into the flask may be more easily monitored.

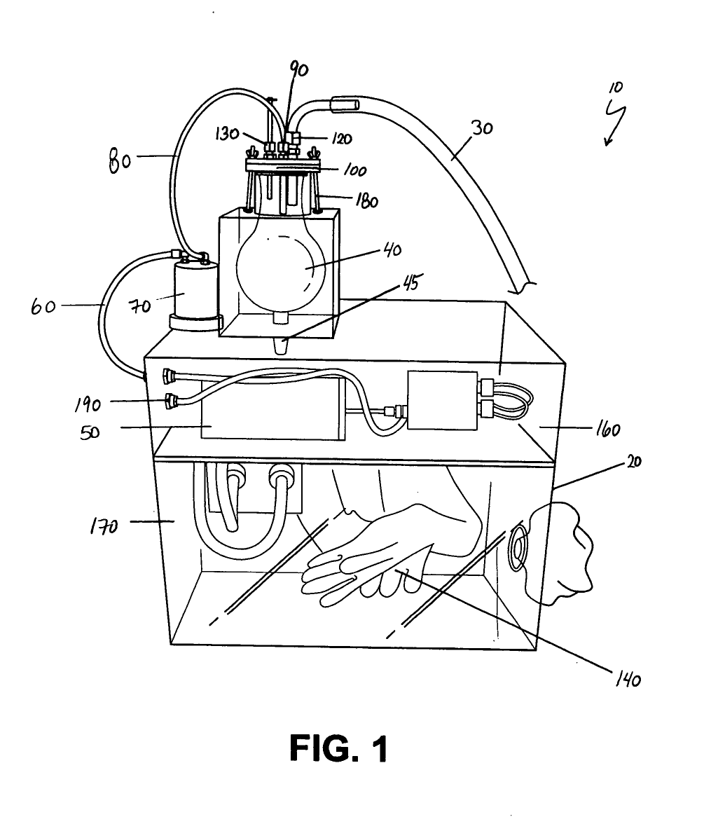

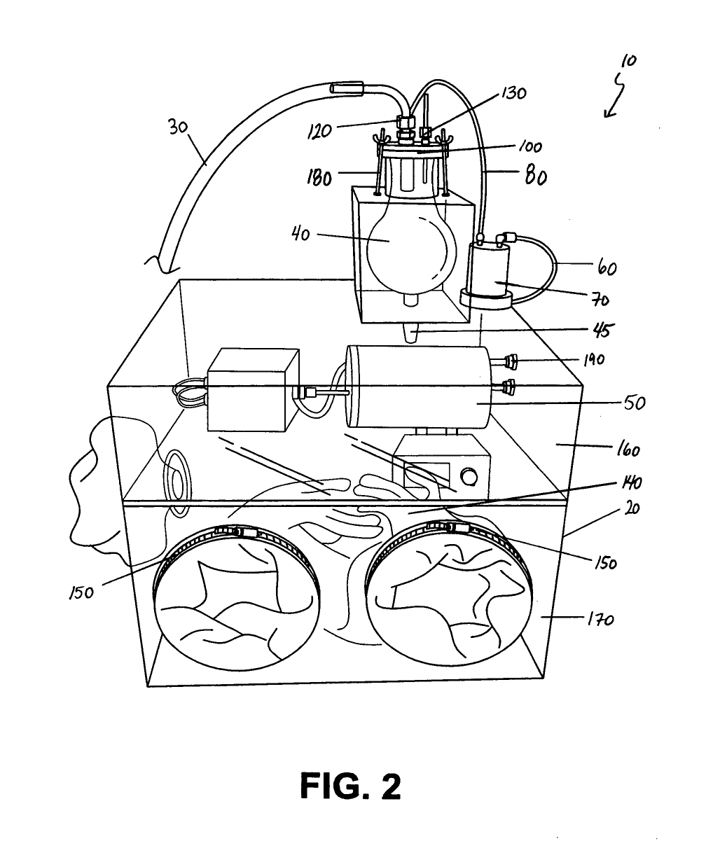

In an alternate embodiment, the container may be attached outside and above the top portion of the chamber thereby making it easier to monitor the collection of liquid into the flask. However, as reduced pressures may be employed to collect liquid samples, it is preferred that the device comprise at least one shield member, and preferably is surrounded by at least one shield member to prevent potential accidents that may occur, for example, during implosion of a defective glass container or the like. The shield member may comprise an extension of the chamber wall and be made of the same substantially transparent material as the chamber. In a preferred embodiment, the chamber and optionally the one or more shield members are made of a substantially transparent acrylic material (for example, but not limited to the representative embodiments shown in FIGS. 1-3). However, in an alternate non-limiting embodiment, the chamber may be made of plastic, for example, but not limited to polypropylene or a similar material that is collapsible and inflatable. In such an embodiment, the container may be inflated with a suitable gas prior to use and deflated after use.

In an embodiment of the present invention, which is not meant to be limiting in any manner, the container is a glass volumetric collection flask comprising an outlet for dispensing collected sample at a first end and an opening at a second end, the first end and second end usually, but not always comprising the respective bottom end portion and top end portion of the flask. The second opening may be sealed with a plug or the like having one or more fittings therein, each fitting extending through an aperture in the plug providing a continuous channel from the interior to the exterior of the flask. Such a fitting may include, but is not limited to a hollow tube made of a suitable material such as, without limitation, glass or metal. In an alternate embodiment, a fitting may comprise screw threads for engaging a screw thread receiving member in the plug. Further, the fitting may comprise a hexagonal member or the like that can be tightened by an appropriate tool such as a wrench or the like.

A portion of each fitting exterior to the flask may be adapted to receive a tube or hose. For example, the exterior portion of the fitting may taper from a large diameter to a small diameter over a length of the fitting for receiving and frictionally engaging a hose or tube that passes over it. In an alternate embodiment, an exterior portion of the fitting may be substantially cylindrical and sized to frictionally engage a hose or tube of a particular diameter that is inserted thereover. In still a further embodiment, the fitting connecting the hose or tube may be connected to the container by a screw thread and screw thread receiving system.

In an embodiment of the present invention, which is not meant to be limiting in any manner, the container comprises a plug having at least two fittings, a first fitting connected to a sample connection tube, and a second fitting connected to a suction hose. In a further embodiment, the collection flask may comprise a third fitting that comprises a valve to equilibrate pressure within the collection flask. In a preferred embodiment, the third fitting is connected to a source of compressed gas to equalize pressure in the container after sufficient sample has been collected. However, pressure in the container may be equalized within the atmospherically-isolated chamber, for example, by opening a valve in the container or disconnecting the suction hose from the container, while the container is inside the atmospherically-isolated chamber.

It is also contemplated that the container may comprise a plug having a single fitting with a plurality of attachment points for one or more pump hoses, collection tubes and pressure equalization sources.

The plug for sealing the opening of the container may be secured in place by one or more securing means. For example, but not to be considered limiting in any manner, the plug may be secured in place by one or more threaded screw members attached at opposite positions along the outer circumference of the plug outside the surface area covering the opening of the container. However, any means known in the art for securing the plug in the opening of the container may be employed by the present invention.

It is also contemplated that an overflow container may be attached in series between the pump and the container to intercept any excess or inadvertant liquid sample that is aspirated or that overflows from the collection flask. For example, but not wishing to be limiting, a first suction hose may be used to connect the container to the overflow container, and a second suction hose may be used to attach the overflow container to the pump. Generally, the two hoses are attached at different positions on the overflow container so that excess liquid accumulates in the overflow container, as would be understood by a person of skill in the art.

In the event that the container comprises a single opening sealed with a plug comprising two fittings wherein an external portion of the first fitting is connected to a sample collection tube or hose, and a second fitting is connected to a suction hose, it is preferred that the first fitting comprises a portion which extends further into the flask than the second fitting. In this way, sample that is collected is less likely to be aspirated into the suction hose via the second fitting. Any other arrangement known in the art to accomplish this effect is also meant to be encompassed by the present invention.

The pump system employed in the device of the present invention may be located outside or inside the chamber. In an embodiment wherein the pump is located inside the chamber, preferably the chamber comprises a compartment, shelf or the like for supporting the pump. As will be appreciated by a person of skill in the art, one or more suction tubes, hoses, power cords or the like may exit the sealed chamber without compromising the integrity of the environment within the chamber. The hoses, tubes, cords and the like may each attach to a connection member comprising a continuous channel in the wall of the chamber. The connection member may be adapted to connect to a hose or tube on either the inside, outside or both, for example, via a screw/screw thread receiving system or the like. Similarly, the connection member for a plug, power cord or electrical wire may be a electrical socket formed in the wall of the chamber. The socket may in turn be attached to a power cord, electrical wire or the like that exits on the outside chamber.

It is also contemplated that the device may comprise a battery, generator or other power source to operate the pump system and/or any other electrical equipment that may be employed in the chamber. In still a further embodiment, but without wishing to be limiting in any manner, it is also contemplated that the pump may be a manually operated pump thereby obviating the need for a power source.

The device of the present invention is preferably portable comprising a size and weight that permits it to be transported to a desired location by a user wishing to obtain liquid samples under atmospherically-isolated conditions.

The sample collection device of the present invention allows for the sampling of aqueous matter under isolated and/or controlled atmospheric conditions. This allows for the specialized sampling of aqueous matter for trace levels of substances including volatile substances without compromising the integrity of the original sampling material. In addition, the device of the present invention permits safe sampling of hazardous aqueous matter.

The present invention will be further illustrated in the following examples, which are not meant to be limiting in any manner.

### EXAMPLES

### Example 1

Referring now to FIGS. 1-3 there is shown a device for collection of liquid samples (10) under atmospherically-isolated conditions, the device comprising a hermetically-sealable chamber (20), and a pump system for drawing liquid through a sampling tube (30) into a container (40) having outlet (45) that extends into chamber (20). The pump system comprises pump (50) comprising first suction hose (60) connected to an overflow container (70) and second suction hose (80) connected to first fitting (90) in plug (100) of container (40). The plug (100) also comprises second fitting (110) attached to sample collection tube (120), and third fitting (130) that may comprise a valve to equalize pressure in container (40).

The means for manipulating samples shown in FIGS. 1-3 comprises two gloves (140) that extend into chamber (20). The gloves (140) are reversibly sealed around an aperture in the chamber such that a person may pass their hands through the aperture into a glove and manipulate samples and other components within the chamber (20) without contaminating the interior of the chamber with the outside environment. Each glove (140) may be sealed to the chamber or a member forming a channel in the chamber by a circular compression clamp (150).

Without wishing to be limiting in any manner, FIGS. 1-3 also show that chamber (20) comprises an upper chamber portion (160) housing a pump (50) and a lower chamber portion (170). In addition, but not to be considered limiting in any manner, plug (100) may be secured in place by two threaded screw members (180) and wing-nuts (190) attached at opposite positions along the outer circumference of the plug outside the surface area covering the opening of the container.

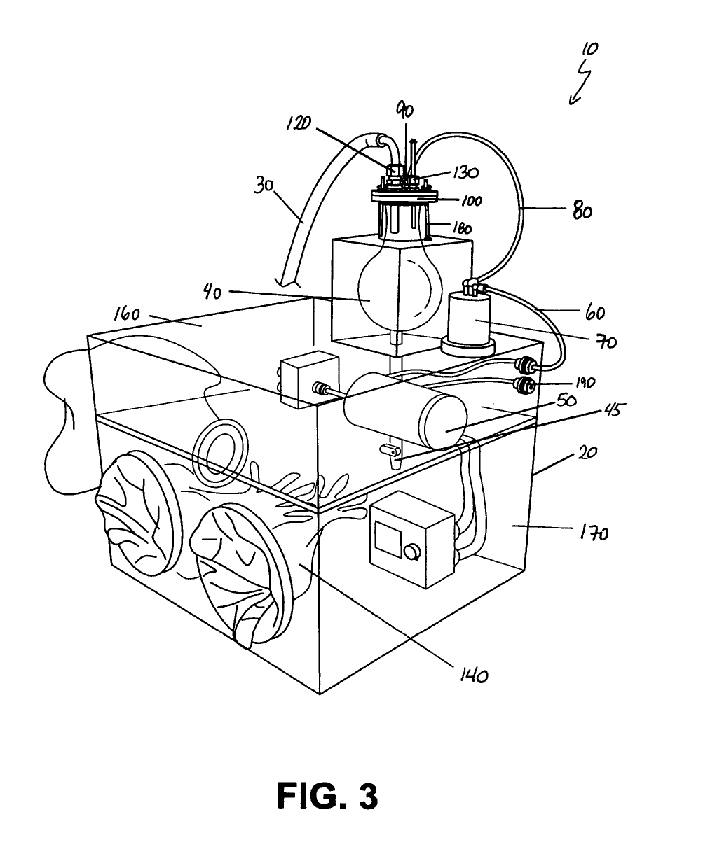

Again, without wishing to be limiting in any manner, FIGS. 1 and 3 also show that a hose, tube, cord or the like may attach to a connection member (190) forming a continuous channel in the wall of the chamber. The connection member (190) may be adapted to connect to a hose or tube on either the inside, outside or both, for example, via a screw/screw thread receiving system or the like. Similarly, the connection member for a plug or power cord may be a electrical socket formed in the wall of the chamber (not shown). The socket may in turn be attached to a power cord or the like that exits outside the chamber.

All citations are hereby incorporated by reference.

The present invention has been described with regard to one or more embodiments. However, it will be apparent to persons skilled in the art that a number of variations and modifications can be made without departing from the scope of the invention as defined in the claims.

What is claimed is:

1. A device for collection of liquid samples under atmospherically-isolated conditions comprising,
a hermetically sealable chamber comprising one or more means for manipulating samples or equipment within the chamber, and;
a pump system for drawing liquid through a sampling tube into a container wherein said container comprises an outlet within the chamber for dispensing said collected sample.

2. The device of claim 1, wherein said atmospherically isolated conditions further comprise atmospherically-controlled conditions.

3. The device of claim 1, wherein the atmospherically-controlled conditions comprise temperature, gas composition, humidity, pressure, or any combination thereof.

4. The device of claim 1, wherein said hermetically sealable chamber comprises a closable door forming an air-tight seal separating the atmosphere in the container from that outside the container.

5. The device of claim 4, further comprising a docking port for transfer of sample within the container to a further container or device under controlled conditions.

6. The device of claim 1, wherein the one or more means for manipulating samples or equipment comprises at least two gloves extending into the chamber.

7. The device of claim 1, wherein said pump system comprises a pump having a suction tube connected directly or indirectly to the container at a first attachment point for reducing pressure therein, and a sampling tube connected to the container at a second attachment point, wherein said liquid sample is drawn into the container via the sampling tube under reduced pressure in the container.

8. The device of claim 7, further comprising an overflow vessel attached between the pump and the container.

9. The device of claim 8, wherein said pump comprises a first suction hose connected to the overflow vessel at a first attachment point, and a second suction hose connecting the overflow vessel at a second attachment point to the container.

10. The device of claim 1, wherein said container comprises a plug having a first fitting attached to a suction hose, and a second fitting attached to a sample collection tube.

11. The device of claim 10, wherein said plug comprises a third fitting having a valve for equalizing pressure within the container.

12. The device of claim 11, wherein said third fitting is connected to a source of compressed gas.

13. The device of claim 1, wherein said chamber comprises one or more connection members in the wall thereof for continuous transmission of
a) a suction force between a hose or tube outside the chamber and a second hose or tube inside the chamber, or
b) an electrical current between a power cord inside the chamber and a power cord outside the chamber.

14. The device of claim 1, wherein said sampling tube comprises a valve or stop-cock to control the flow of liquid therethrough.

15. A device for collection of liquid samples under atmospherically-isolated conditions comprising,
a hermetically sealable chamber comprising one or more means for manipulating samples or equipment within the chamber, and;
a pump system for moving liquid through a sampling tube, said pump system comprising an outlet within said chamber for dispensing collected liquid sample.
